(19) United States
(12) Patent Application Publication
(10) Pub. No.: US 2024/0114029 A1
(43) Pub. Date: Apr. 4, 2024

(54) METHODS AND APPARATUS FOR IDENTITY AND ACCESS MANAGEMENT ON NETWORKED MACHINES

(71) Applicant: Intel Corporation, Santa Clara, CA (US)

(72) Inventors: Christopher Son Thach, Ambler, PA (US); Nathan John Heldt-Sheller, Portland, OR (US); Radoslaw Benedykt Szulim, Kensington, MD (US); Ned Smith, Beaverton, OR (US); Matthew David Balvin, Beaverton, WA (US); Callum Wilson Noble, Sunnyvale, CA (US); Anand Basalingappa Jyoti, Bangalore (IN)

(21) Appl. No.: 18/538,973

(22) Filed: Dec. 13, 2023

(51) Int. Cl. H04L 9/40

(52) U.S. Cl. CPC H04L 63/10

(57) ABSTRACT

Methods and apparatus for identity and access management on networked machines are disclosed herein. An example non-transitory machine readable storage medium includes instructions to cause programmable circuitry to at least grant first permission to form a connection between a remote compute device and a local compute device based on a first identity of a first account, the connection to enable the first account to operate the local compute device by impersonating a second user, the second user associated with a second identity, access a request to execute a command on the remote compute device from the first account, and determine, based on the first identity of the first account and the second identity of the second user, whether second permission is to be granted to execute the command.

### FIELD OF THE DISCLOSURE

This disclosure relates generally to access management and, more particularly, to methods and apparatus for identity and access management on networked machines.

### BACKGROUND

Identity and access management systems control and regulate access to compute resources based on the identity of the accessor. Some identity and access management systems include three subsystems, namely an identity subsystem, a policy subsystem, and an enforcement subsystem. Identity subsystems manage and authenticate the identity of users of the compute resources. Policy subsystems include one or more rules that define what compute resources can be accessed based on the identity of a user. Enforcement subsystems enforce the rules managed by the policy subsystem and prevent unauthorized users from gaining access to compute resources.

### BRIEF DESCRIPTION OF THE DRAWINGS

FIG. 1 is a block diagram of an example environment in which remote compute device may access a local compute device.

FIG. 2A is a block diagram of an example implementation of the remote access manager circuitry of FIG. 1.

FIG. 2B is a block diagram of an example implementation of the local access manager circuitry of FIG. 1.

FIG. 2C is a block diagram of an example implementation of the permission manager circuitry of FIG. 1.

FIG. 3 is a flowchart representative of example machine readable instructions and/or example operations that may be executed, instantiated, and/or performed by example programmable circuitry to implement the remote access manager circuitry of FIG. 2A.

FIG. 4 is a flowchart representative of example machine readable instructions and/or example operations that may be executed, instantiated, and/or performed by example programmable circuitry to implement the local access manager circuitry of FIG. 2B.

FIG. 5 is a flowchart representative of example machine readable instructions and/or example operations that may be executed, instantiated, and/or performed by example programmable circuitry to implement the permission manager circuitry of FIG. 2C.

FIG. 6 is a communication diagram representing example communications exchanged among the remote compute device, the permission server, and the local compute device of FIG. 1.

FIG. 7 is a block diagram of an example processing platform including programmable circuitry structured to execute, instantiate, and/or perform the example machine readable instructions and/or perform the example operations of FIG. 4 to implement the remote access manager circuitry of FIG. 2A.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4, 5, and/or 6, etc.) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Customer support, troubleshooting, debugging, remote work, monitoring, parent control, employee controls, and other activities can be performed remotely on networked compute devices by other devices over a network. For example, a remote compute device can establish a connection with a local machine that enables the remote compute device to execute commands on the local compute device. Some such connections enable a user of the remote compute device to operate the local compute device as if the user had a different identity. For example, a remote debugger can operate a local compute device as if the remote debugger was another user of the computer (referred to herein as “impersonating” an identity of that user). Impersonating an identity can enable the remote debugger via a subset of the privileges associated with the impersonated identity (e.g., some of the privileges, all of the privileges, etc.). Impersonating can enable the remote operators to recreate situations (e.g., bugs, errors, computing environments, etc.) encountered by the other user. However, impersonating and/or higher permission levels another operator can grant the remote operator access to more resources on the local compute device than necessary to complete the intended task of the remote operator. Particularly, privileges on a local compute device can be coarse and the least privileged access required to execute the intended task of the remote accessor can expose potentially sensitive data to the remote accessor. As such, if a malicious actor can gain access to a local compute user by impersonating another user, the malicious actor can have broad authority to access the resources of the local computer. Prior systems for remote access are susceptible to privilege escalation, in which excessive privileges were granted to remote accessors.

Examples disclosed herein overcome the above-noted deficiencies and include a remote interface where commands submitted from remote compute devices require individualized authorization by an identity and access management system (IAM) before execution on the local compute device. In some examples disclosed herein, the identity and access management system analyzes the requested command and determines whether to authorize the command based on the identity of the account operating the remote compute device, the identity being impersonated on the local compute device, attributes related to the accessed resource, and/or the communication protocol used between the remote compute device and the local compute device. In some examples disclosed herein, the identity and access management system (IAM) can issue a time-sensitive authorization, which expires after a predetermined period of time. In some examples disclosed herein, the commands that export (e.g., output, etc.) data to the remote compute device can be subjected to additional scrutiny to prevent the leak of potentially sensitive communications. Examples disclosed herein reduce the likelihood of privilege escalation and the leak of sensitive data to unauthorized users.

As used herein, the terms “remote” and “local” are simply used to refer to two different compute devices without implying any actual physical or virtual distance between the compute devices. A remote compute device and a local compute device may be on the same or different networks, at same or different physical locations, etc.

As used herein, the term “account” refers to a digital record associated with a user of a compute device, wherein the record is used to access the compute device. In some examples, accounts can have different levels of access associated with the account, which govern what a user of the account can access via the compute device (e.g., which protection ring the account can access, admin level access, etc.). As used herein, the term “identity” refers to personal identity information related to a user of a compute device (e.g., the name of the user, the title of the user, the age of the user, etc.). A user of a compute device can have multiple accounts but has a single identity.

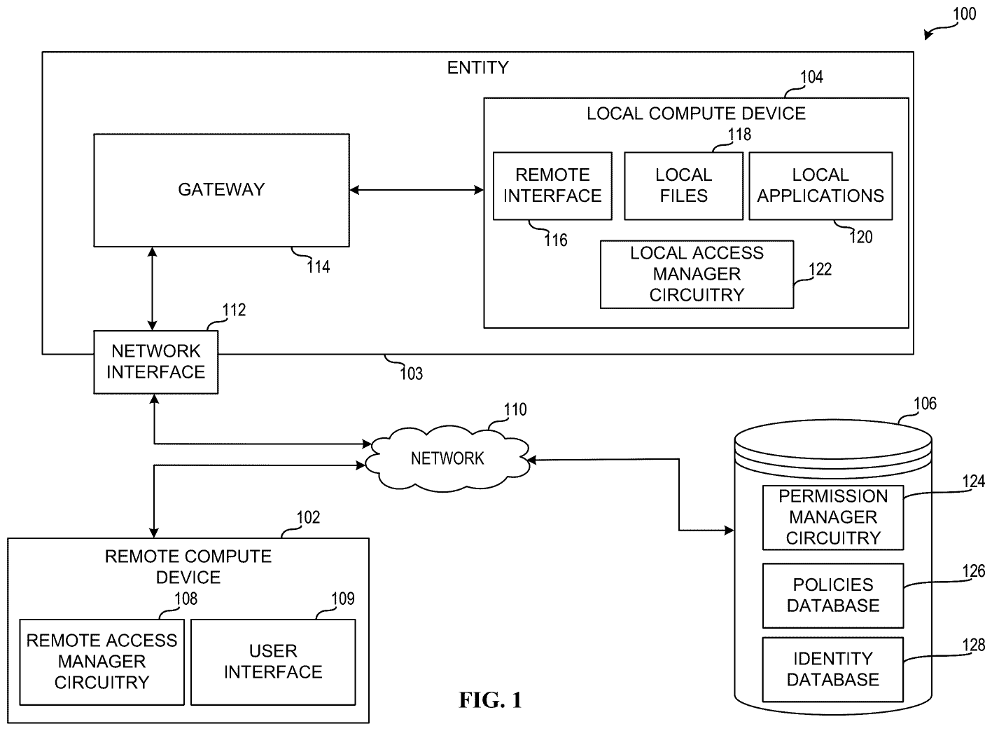

FIG. 1 is a block diagram of an example environment 100 in which remote compute device may access a local compute device. In the illustrated example of FIG. 1, the environment 100 includes an example remote compute device 102, an example entity 103 including an example local compute device 104, and an example identity and access management server 106. In the illustrated example of FIG. 1, the remote compute device 102 includes example remote access management circuitry 108 and an example user interface 109. In the illustrated example of FIG. 1, the remote compute device 102 communicates with the local compute device 104 via an example network 110, an example network interface 112 of the entity 103, and an example gateway 114. In the illustrated example of FIG. 1, the local compute device 104 includes an example remote interface 116, example local files 118, example local applications 120, and example local access manager circuitry 122. In the illustrated example of FIG. 1, the identity and access management server 106 includes example permission manager circuitry 124, an example policy database 126, and an example identity database 128.

The remote compute device 102 is a compute device that can establish a connection with the local compute device 104 and execute commands remotely thereon. For example, the remote compute device 102 can be a debug workstation. Additionally or alternatively, the remote compute device 102 can be one or more of a personal computer (PC), a server, a workstation, a mobile device (e.g., a smartphone, a tablet, a smartwatch, a personal digital assistant, etc.), and/or any other type of compute device. The user interface 109 of the remote compute device 102 permits a user of the remote compute device 102 to input and receive information from the remote compute device 102. For example, the user interface 109 can include one or more of a keyboard, a mouse, a touchscreen, a speaker, a display, etc.

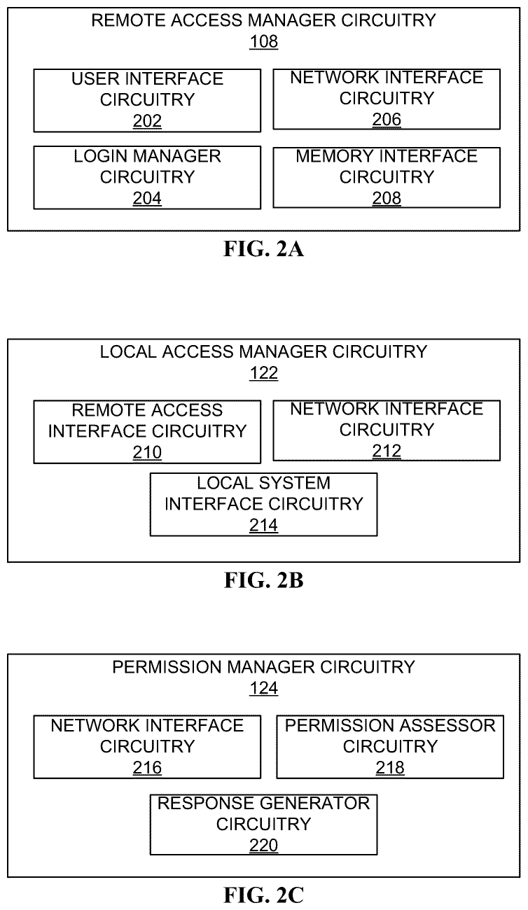

The remote access manager circuitry 108 manages the relationship between the remote compute device 102, the entity 103 (e.g., the local compute device 104, etc.), and/or the identity and access management server 106. In some examples, the remote access manager circuitry 108 controls access to the remote compute device 102 based on the credentials associated with a local user of the remote compute device 102. In some examples, after receiving credentials (e.g., input via the user interface 109, etc.), the remote access manager circuitry 108 can communicate with the identity and access management server 106 to determine whether to grant permission to access the remote compute device 102 is to be granted (e.g., whether an account associated with the credentials will be permitted to login into the remote compute device 102, etc.). The remote access manager circuitry 108 can establish a connection between the remote compute device 102 and other compute devices. In some examples, the remote access manager circuitry 108 controls access to the remote compute device 102, based on the credentials associated with a local user of the remote compute device 102. In other examples, the remote compute device 102 can have a different identity and access management server (e.g., a disparate identity and access management server, etc.) than the identity and access management server 106. In some such examples, the remote compute device 102 can communicate with said IAM server to verify the credentials of the remote compute device 102. The remote access manager circuitry 108 can send commands (e.g., input by the user interface 109, etc.) to the remote interface 116 to be executed by the local compute device 104. An example implementation of the remote access manager circuitry 108 is described below in conjunction with FIG. 2A.

The entity 103 is a portion (e.g., an element, etc.) of a subsystem that communicates with other entities via a communication protocol. For example, the entity 103 can be a node of an edge resource network. Additionally or alternatively, the entity 103 can be a network of computers (e.g., a local area network of computers, a wide area network of computers, a campus area network of computers, etc.). In some examples, the entity 103 can be absent. In some examples, the remote compute device 102 is part of the entity 103. In some such examples, the local compute device 104 can be an independent device (e.g., not part of a network and/or collection of related devices, etc.). In some examples, the network interface 112 of the entity 103 can be absent and/or a component of the gateway 114. In some examples, the entity 103 can facilitate a multi-tenant sharing of the local compute device 104 and/or other machines associated with the entity 103.

The network 110 enables communications between the remote compute device 102 (e.g., the remote access manager circuitry 108, etc.), the entity 103, the local compute device 104 (e.g., the local access manager circuitry 122, etc.), the identity and access management server 106, and other network entities (e.g., other machines, etc.). In some examples, the network 110 can be implemented as a cellular network, the internet, or any other suitable wide area network (WAN). In other examples, the network 110 can be a wired connection. In some examples, the network 110 can be implemented via multiple networks (e.g., a local area network coupled to a wide area network, etc.). In some such examples, the remote compute device 102 communicates with the entity 103 (e.g., the local compute device 104, etc.) via a first network (e.g., the Internet, etc.), and the entity 103 communicates with the identity and access management server 106 via a second network (e.g., a LAN, a WAN, a wired connection, etc.).

The network interface 112 is a component of the network that connects the entity 103 to the network 110. For example, the network interface 112 can be a network interface card (NIC). In some examples, the network interface 112 can be a component of the local compute device 104. In the illustrated example of FIG. 1, the entity 103 includes the gateway 114. The gateway 114 communicatively couples the local compute device 104 to the network interface 112. The gateway 114 manages the flow of information flowing into and out of the local compute device 104. In some examples, the gateway 114 is an ingress gateway.

The local compute device 104 is a compute device associated with the entity 103. For example, the local compute device 104 can be an application pod of an edge node (e.g., the entity 103, etc.). In some examples, the local files 118, the local applications 120, and/or the local access manager circuitry 122 can be instantiated by other hardware components of the entity 103. In other examples, the local compute device 104 can be independent from a network of other related compute devices. In some examples, the local compute device 104 can be one or more of a personal computer (PC), a server, a workstation, a mobile device (e.g., a smartphone, a tablet, a smartwatch, a person digital assistant, etc.), and/or any other type of compute device. Additionally or alternatively, the local compute device 104 can be a virtual machine. In some such examples, the local compute device 104 can be implemented via a plurality of physical machines.

The local compute device 104 can have one or more typical user(s) who have corresponding accounts and identities. During the operation of the local compute device 104, a regular user of the local compute device 104 may encounter one or more situations (e.g., errors, bugs, a situation requiring additional higher access, etc.) that prompt a user of the remote compute device 102 to form a connection with the local compute device 104. In some such examples, an account of the remote compute device 102 can form a connection with the local compute device 104 (e.g., a transmission control protocol/internet protocol (TCP/IP) connection, a wireless transmission control protocol (WTCP) connection, a Bluetooth connection, etc.) and operate the local compute device 104 by impersonating the second account to address the encountered situation. Additionally or alternatively, the remote compute device 102 can form a connection with the local compute device 104 for another purpose (e.g., monitoring of an account associated with the local compute device 104, maintenance of the local compute device 104, updating software associated with the account and/or the local compute device, etc.).

The remote interface 116 permits commands to be executed on the local compute device 104 based on one or more inputs from the user interface 109 of the remote compute device 102. In some examples, the remote interface 116 can enable a first account of the remote compute device 102 to execute commands on the local compute device 104 as a second account associated with a different user of the local compute device 104, which can enable the user of the remote compute device 102 to execute commands as if the local compute device 104 was being operated by the second account. In some examples, the remote interface 116 can permit a user of the remote compute device 102 to encounter (e.g., recreate, etc.) errors and/or problems that were previously encountered by the second account on the local compute device 104. In some examples, the remote interface 116 can be implemented by a shell interface, a remote desktop tool, a debugging interface, a command prompt tool, an application programming interface (API), and/or any other suitable interface.

In the illustrated example of FIG. 1, the remote interface 116 is illustrated as a separate component from the local access manager circuitry 122. In other examples, the remote interface 116 can be part of the local access manager circuitry 122. In some examples, the remote interface 116 can have integrated authorization and authentication capabilities, which can prompt the local access manager circuitry 122 to send one or more authentication/authorization requests to the identity and access management server 106 in response to one or more requested commands from the remote compute device 102. For example, the remote interface 116 can implement authorization and/or authentication protocols (e.g., Open Authorization 2.0 (OAuth 2.0), Security Assertion Markup Language (SAML), SAML 2.0, etc.). During remote operation of the local compute device 104 by the remote compute device 102 via the remote interface 116, the remote interface 116 can include a data structure (e.g., a string, a floating point number, an integer, a token, etc.) that is indicative of the identity of the account of the user operating the remote compute device 102. In some such examples, the data structure indicative of the identity of the account of the user of the remote compute device 102 enables the permission manager circuitry 124 to make authentication/authorization decisions based on the identity of the account operating the remote compute device 102 and the identity of the user of the local compute device 104 being impersonated by the remote interface 116 (e.g., the identity where a subset of the privileges of the identity are being used by the remote interface 116, etc.).

The local files 118 are data structures and/or resources stored on a memory of and/or accessible to the local compute device 104. For example, the local files 118 can include one or more data structures (e.g., text files, images, spreadsheets, videos, programs, etc.). In some examples, access to ones of the local files 118 can be controlled by the permission manager circuitry 124. For example, the policy database 126 can include policies that regulate which accounts can access the local files 118 based on the identities associated with the identity database 128. The local applications 120 are resources stored on a memory of and/or accessible by the local compute device 104. For example, the local applications 120 can include software and/or other computer programs. During operation, the remote interface 116 can, based on one or more inputs from the remote compute device 102, cause the local compute device 104 to execute one or more commands. For example, the remote interface 116 can cause the local compute device 104 to execute a command to access (e.g., open, etc.) one or more of the local files 118, output one or more of the local files 118 to the remote compute device 102, and/or execute one of the local applications.

The local access manager circuitry 122 manages the connection between the local compute device 104 and the remote compute device 102 and communications between the local compute device 104 and the identity and access management server 106 to receive authorization and/or authentication to execute commands on the local compute device 104. For example, the local access manager circuitry 122 can send a communication to the identity and access management server 106 that requests permission/authorization to execute the requested command In some examples, the local access manager circuitry 122 can send an authorization request to the identity and access management server 106 that includes a first data structure indicative of a first identity of the account operating the remote compute device 102 and a second data structure indicative of a second account that is being utilized (e.g., impersonated, etc.) by the remote interface 116. In some examples, the local access manager circuitry 122 can receive and store an authorization token (e.g., an OAuth 2.0 token, etc.) from the identity and access management server 106 on a memory associated with the local compute device 104 and/or the remote compute device 102.

The identity and access management (IAM) server 106 is a server that manages the identities of accounts associated with and access to the entity 103 and/or the remote compute device 102. In the illustrated example of FIG. 1, the identity and access management server 106 includes the permission manager circuitry 124. The permission manager circuitry 124 receives requests to access the compute devices 102, 104, requests to form a connection between the remote compute device 102 and the local compute device 104, and to execute commands on the local compute device 104 by the remote interface 116. For example, the permission manager circuitry 124 can decide whether to authorize the execution of the command based on the identity of the account operating the remote compute device 102 (e.g., a first identity of a first account associated with a first user, etc.) and the identity of the account being impersonated by the remote interface 116 (e.g., a second identity of a second account associated with a second user, etc.). In some examples, the identity and access management (IAM) server 106 enables the local compute device 104 to be debugged without rebooting the local compute device 104. That is, the remote interface 116 enables the presentation of credentials and/or other information to the identity and access management (IAM) server 106 without restarting the local compute device 104. In some examples, the permission manager circuitry 124 can further determine whether to grant permission based on the first identity, the second identity, and the policies stored in the policy database 126. An example implementation of the permission manager circuitry 124 is described below in conjunction with FIG. 2C.

The policy database 126 is a database (e.g., physical memory, virtual memory, etc.) that stores information related to the policies that govern access to compute resources of the entity 103 and/or the local compute device 104. As used herein, a “policy” defines the circumstances in which a particular resource can be accessed. Policies can be identity-based (e.g., a particular identity has access to defined a set of resources, etc.) and/or resource-based (e.g., a particular compute resource is permitted to be accessed by a defined set group of identities, etc.). As used herein, the terms “policies” and “rules” are used interchangeably. For example, the policy database 126 can include one or more policies that govern the access to the local files 118 and the local applications 120 by users of the compute devices 102, 104.

In some examples, the policies stored in the policy database 126 can be associated with multiple identities. For example, if commands are being executed remotely (e.g., by the remote compute device 102 via the remote interface 116, etc.), the policies stored in the policy database 126 can be based on both the identity of the account operating the remote compute device 102 and the identity being impersonated by the remote interface 116. In some examples, the policies could expand the privileges of the identity of the account operating the remote compute device 102 based on the account being impersonated by the remote interface 116. That is, the policies could restrict access to a resource (e.g., one of the local files 118, the local applications 120, etc.) associated with a protection ring that is more privileged than the protection ring to which the first identity has access to (e.g., the resource is a first level protection ring resource, the identity has access to a second level protection rings, etc.). For example, the policies could expand the privileges of the identity being impersonated by the remote interface 116 based on the identity of the account operating the remote compute device 102. For example, if the identity being impersonated by the remote interface 116 is unprivileged (e.g., a standard user, etc.), the policies of the policy database 126 could permit the remote interface 116 to access sensitive system resources, despite the impersonated identity not otherwise having access to such system resources. For example, if the remote interface 116 is being used by an account having a privileged identity and the impersonated identity is a standard user, the policies could permit the remote interface 116 to undertake debugging actions, install new applications, and/or edit restricted ones of the local files 118. Similarly, if the remote interface 116 is being used by an account associated with an adult and the impersonated identity is associated with a minor, the policies could permit the remote interface 116 to change the parental settings of the local compute device 104. It should be appreciated that other policies that increase the privileges of the impersonated account while being impersonated are encompassed by teachings of this disclosure.

Additionally or alternatively, the policies could restrict the privileges of the identity being impersonated by the remote interface 116 based on the identity of the account operating the remote compute device 102. That is, the policies could restrict access to a resource (e.g., one of the local files 118, the local applications 120, etc.) associated with a protection ring that is less privileged than the protection ring to which the first identity has access to (e.g., the resource is a second level protection ring resource, the identity has access to a first level protection rings, etc.). For example, if the identity being impersonated by the remote interface 116 is highly privileged (e.g., an administrator, a privileged user, etc.) and/or has access to sensitive information (e.g., classified information, private information related to other users, trade secrets, etc.), the policies of the policy database 126 could restrict access to sensitive system resources by the remote interface 116, despite the impersonated identity otherwise having access to the sensitive system resources. For example, if the remote interface 116 is being used to debug the local compute device 104 and the impersonated identity is associated with an accountant, the policies could restrict access to system resources unrelated to the debugging and associated with confidential financial information (e.g., payroll information, tax information, revenues, etc.). Similarly, if the remote interface 116 is being used to debug the local compute device 104 and the impersonated identity is associated with a person having a security clearance, the policies could restrict access to system resources unrelated to the debugging and associated with classified information. It should be appreciated that other policies that reduce the privileges of the impersonated account while being impersonated are encompassed by the teachings of this disclosure.

The identity database 128 is a database (e.g., physical memory, virtual memory, etc.) that stores information related to the identities associated with specific user accounts and privileges associated with the identities. For example, the identity database 128 can include a database that relates a user account to an identity and/or the permitted privileges associated with the account. In some such examples, the identity database 128 can include an indication of which protection ring level (e.g., kernel level, driver level, application level, etc.) the account and/or identity has permission to access. Additionally or alternatively, the identity database 128 can include an indication of which zones of trust the identity has permission to access. In some examples, the identity database 128 includes one or more data structures (e.g., hash tables, etc.) that relate identities to particular sets of credentials. In some such examples, the permission manager circuitry 124 can use the identity database 128 to determine whether the accessing of the remote compute device 102 by a local user is to be authorized (e.g., whether permission to login into the remote compute device 102 by a first account having the first identity, etc.). In some examples, the permission manager circuitry 124 can use the identity database 128 to determine whether to authorize the execution of a command based on the identities associated with the request (e.g., the identity of the account operating the remote compute device 102, the identity of the account being impersonated by the remote interface 116, etc.) and the policies of the policy database 126.

In the illustrated example of FIG. 1, the permission manager circuitry 124, the policy database 126, and the identity database 128 are depicted as components of the identity and access management server 106. That is, the identity and access management server 106 is depicted as a centralized IAM provider that controls the access and authorization for the remote compute device 102 and the entity 103. Additionally or alternatively, the identity and access management server 106 can be implemented by multiple servers and/or at multiple locations (e.g., physical locations, the cloud, etc.). In other examples, some or all of the permission manager circuitry 124, the policy database 126, and the identity database 128 can be distributed between the remote compute device 102, the local compute device 104, and/or other components of the entity 103.

FIG. 2A is a block diagram of an example implementation of the remote access manager circuitry 108 of FIG. 1 to form a connection with the local compute device 104 of FIG. 1 and to execute operations thereon. In the illustrated example of FIG. 2A, the remote access manager circuitry 108 includes example user interface circuitry 202, example login manager circuitry 204, example network interface circuitry 206, and example memory interface circuitry 208. The remote access manager circuitry 108 of FIG. 2A may be instantiated (e.g., creating an instance of, bring into being for any length of time, materialize, implement, etc.) by programmable circuitry such as a Central Processor Unit (CPU) executing first instructions. Additionally or alternatively, the remote access manager circuitry 108 of FIG. 2A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2A may, thus, be instantiated at the same or different times. Some or all of the circuitry of FIG. 2A may be instantiated, for example, in one or more threads executing concurrently on hardware and/or in series on hardware. Moreover, in some examples, some or all of the circuitry of FIG. 2A may be implemented by microprocessor circuitry executing instructions and/or FPGA circuitry performing operations to implement one or more virtual machines and/or containers.

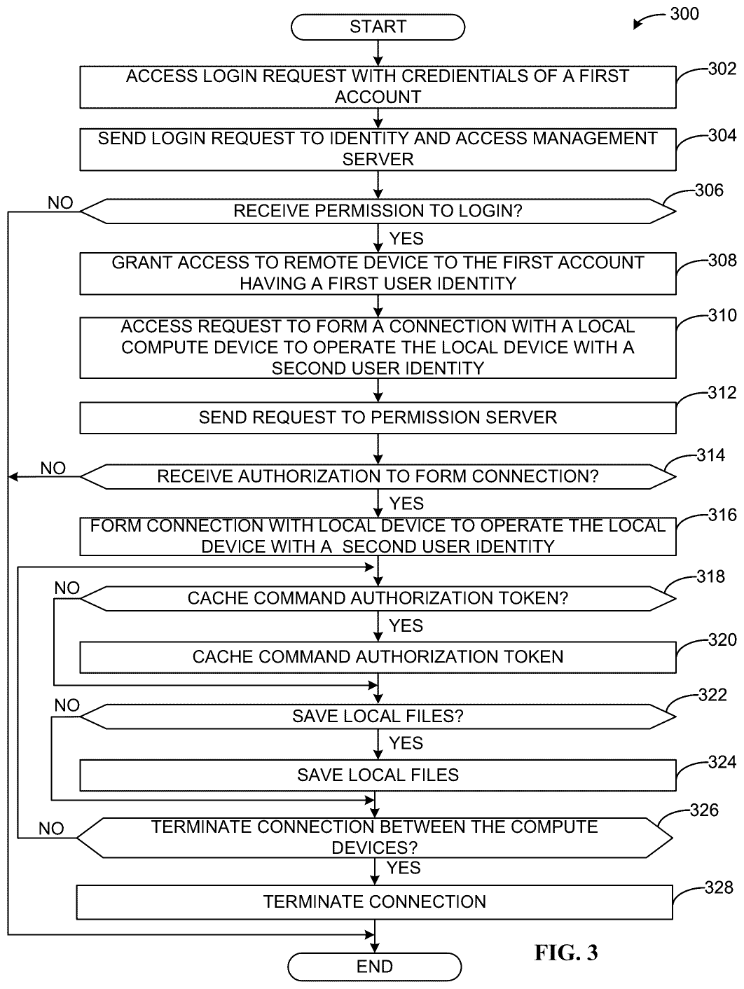

The user interface circuitry 202 accesses and outputs information to a user of the remote compute device 102 via the user interface 109 (e.g., a display, a speaker, etc.). For example, the user interface circuitry 202 can access information input via the information (e.g., credentials, etc.) used by a user to login into the remote compute device 102. In some examples, the user interface circuitry 202 accesses a request to form a connection between the devices 102, 104. In some examples, the user interface circuitry 202 accesses a request to execute a command on the local compute device 104, which can be sent to the remote interface 116 via the network interface circuitry 206. In some examples, the user interface circuitry 202 can output an indication that a command has been executed by the local compute device 104 and/or an indication that permission to execute the command has been denied by the identity and access management server 106. In some examples, the user interface circuitry 202 can output information visually (e.g., via a display, via an indicator light, etc.), audibly (e.g., via a speaker, etc.), and/or tactilely (e.g., via a vibration, etc.). In some examples, the user interface circuitry 202 is instantiated by programmable circuitry executing user interface instructions and/or configured to perform operations such as those represented by the flowcharts of FIG. 3.

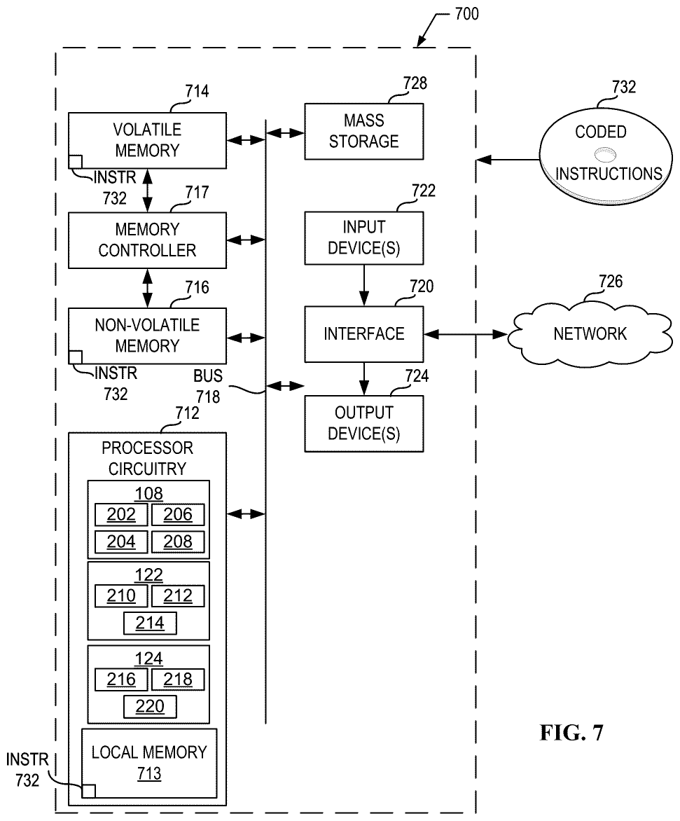

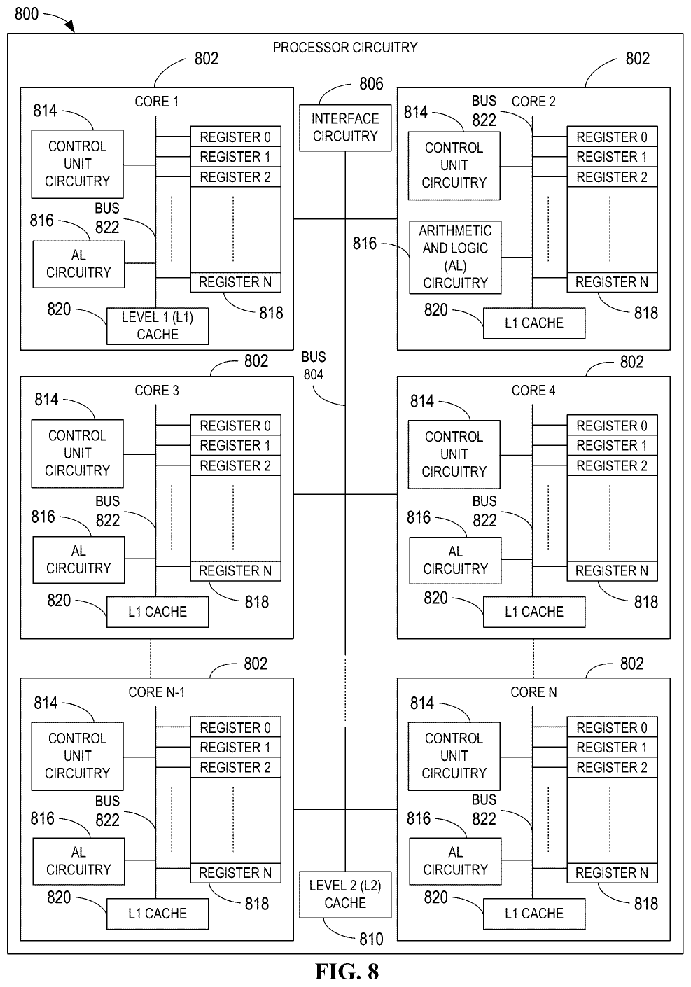

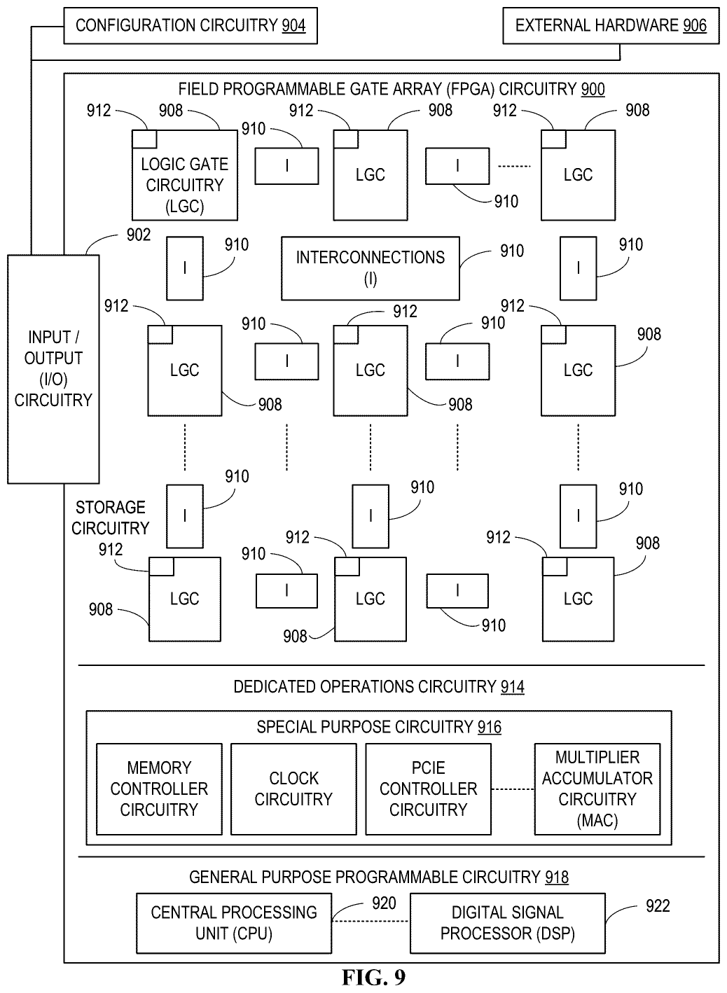

In some examples, the remote access manager circuitry 108 includes means for interfacing with a user. For example, the means for interfacing with a user may be implemented by the user interface circuitry 202. In some examples, the user interface circuitry 202 may be instantiated by programmable circuitry such as the example programmable circuitry 712 of FIG. 7. For instance, the user interface circuitry 202 may be instantiated by the example microprocessor 800 of FIG. 8 executing machine executable instructions such as those implemented by at least blocks 302, 310 of FIG. 3. In some examples, the user interface circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the user interface circuitry 202 may be instantiated by any other combination of hardware, software, and/or firmware. For example, the user interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The login manager circuitry 204 logins an account into the remote compute device 102 after receiving authorization from the identity and access management server 106. For example, the login manager circuitry 204 can log in an account into the remote compute device 102 after the identity and access management server 106 verifies the credentials received via the user interface circuitry 202 are corrected. In some examples, the login manager circuitry 204 can grant an account access to files and applications of the remote compute device 102 that correspond to the access level of the account. In some examples, the login manager circuitry 204 is instantiated by programmable circuitry executing login manager instructions and/or configured to perform operations such as those represented by the flowcharts of FIG. 3.

In some examples, the remote access manager circuitry 108 includes means for logging into a compute device. For example, the means for logging into a compute device may be implemented by the login manager circuitry 204. In some examples, the login manager circuitry 204 may be instantiated by programmable circuitry such as the example programmable circuitry 712 of FIG. 7. For instance, the login manager circuitry 204 may be instantiated by the example microprocessor 800 of FIG. 8 executing machine executable instructions such as those implemented by at least block 308 of FIG. 3. In some examples, the login manager circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the login manager circuitry 204 may be instantiated by any other combination of hardware, software, and/or firmware. For example, the login manager circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The network interface circuitry 206 interfaces with the network 110 can be used to exchange communications with the identity and access management server 106 and the entity 103 (e.g., the local compute device 104, etc.). For example, the network interface circuitry 206 can be used to send credentials to the identity and access management server 106 to enable the login manager circuitry 204 to login an account into the remote compute device 102. In some examples, the network interface circuitry 206 interfaces with the remote interface 116 to enable a user to request execution of a command via the local compute device 104. In some examples, the network interface circuitry 206 can receive ones of the local files 118 and/or command authorization tokens to be saved on a memory associated with the local compute device 104. In some examples, the network interface circuitry 206 is instantiated by programmable circuitry executing network interface instructions and/or configured to perform operations such as those represented by the flowchart of FIG. 3.

In some examples, the remote access manager circuitry 108 includes means for interfacing with a network. For example, the means for interfacing with a network may be implemented by the network interface circuitry 206. In some examples, the network interface circuitry 206 may be instantiated by programmable circuitry such as the example programmable circuitry 712 of FIG. 7. For instance, the network interface circuitry 206 may be instantiated by the example microprocessor 800 of FIG. 8 executing machine executable instructions such as those implemented by at least blocks 304, 306, 312, 314, 318, 326, 328 of FIG. 3. In some examples, the network interface circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the network interface circuitry 206 may be instantiated by any other combination of hardware, software, and/or firmware. For example, the network interface circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The memory interface circuitry 208 interfaces with a memory associated with the remote compute device 102. For example, the memory interface circuitry 208 can access and/or save files to a local memory (e.g., the local memory 713 of FIG. 7, etc.), in a volatile memory (e.g., the volatile memory 714 of FIG. 7, etc.), in a non-volatile memory (e.g., the non-volatile memory 716 of FIG. 7, etc.), and/or in a mass storage device (e.g., the mass storage device 728 of FIG. 7, etc.). In some examples, the memory interface circuitry 208 saves command authorization tokens to a memory of the remote compute device 102. In some examples, the memory interface circuitry 208 saves information (e.g., a portion of the local files 118, etc.) exported by the local compute device 104 to a memory of the remote compute device 102. In some examples, the memory interface circuitry 208 is instantiated by programmable circuitry executing memory interface instructions and/or configured to perform operations such as those represented by the flowchart of FIG. 3.

In some examples, the remote access manager circuitry 108 includes means for interfacing with a memory. For example, the means for interfacing with a memory may be implemented by the memory interface circuitry 208. In some examples, the memory interface circuitry 208 may be instantiated by programmable circuitry such as the example programmable circuitry 712 of FIG. 7. For instance, the memory interface circuitry 208 may be instantiated by the example microprocessor 800 of FIG. 8 executing machine executable instructions such as those implemented by at least blocks 318, 320, 322, 324 of FIG. 3. In some examples, the memory interface circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the memory interface circuitry 208 may be instantiated by any other combination of hardware, software, and/or firmware. For example, the memory interface circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the remote access manager circuitry 108 of FIG. 1 is illustrated in FIG. 2A, one or more of the elements, processes, and/or devices illustrated in FIG. 2A may be combined, divided, re-arranged, omitted, eliminated, and/or implemented in any other way. Further, the example user interface circuitry 202, the example login manager circuitry 204, the example network interface circuitry 206, the example memory interface circuitry 208, and/or, more generally, the example remote access manager circuitry 108 of FIG. 2A, may be implemented by hardware alone or by hardware in combination with software and/or firmware. Thus, for example, any of the example user interface circuitry 202, the example login manager circuitry 204, the example network interface circuitry 206, the example memory interface circuitry 208, and/or, more generally, the example remote access manager circuitry 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example remote access manager circuitry 108 of FIG. 2A may include one or more elements, processes, and/or devices in addition to, or instead of, those illustrated in FIG. 2A, and/or may include more than one of any or all of the illustrated elements, processes and devices.

FIG. 2B is a block diagram of an example implementation of the local access manager circuitry 122 of FIG. 1 to form connection with the remote compute device 102 of FIG. 1, perform operations via the local files 118 and the local applications 120, and manage permission thereto via communications with the identity and access management server 106. In the illustrated example of FIG. 2B, the local access manager circuitry 122 includes example remote access interface circuitry 210, example network interface circuitry 212, and example local system interface circuitry 214. The local access manager circuitry 122 of FIG. 2B may be instantiated (e.g., creating an instance of, bring into being for any length of time, materialize, implement, etc.) by programmable circuitry such as a Central Processor Unit (CPU) executing first instructions. Additionally or alternatively, the local access manager circuitry 122 of FIG. 2B may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2B may, thus, be instantiated at the same or different times. Some or all of the circuitry of FIG. 2B may be instantiated, for example, in one or more threads executing concurrently on hardware and/or in series on hardware. Moreover, in some examples, some or all of the circuitry of FIG. 2B may be implemented by microprocessor circuitry executing instructions and/or FPGA circuitry performing operations to implement one or more virtual machines and/or containers.

The remote access interface circuitry 210 enables the remote interface 116 to interface with and execute commands via the local compute device 104. For example, the remote access interface circuitry 210 can enable the remote interface 116 to send a command to the local system interface circuitry 214 to access and/or modify one or more of the local files 118 and/or to execute one or more of the local applications. In some examples, the remote access interface circuitry 210 can output (e.g., export, etc.) one or more of the local files 118 to the remote interface 116, which can then be sent to the remote compute device 102 via the network interface circuitry 212. In some examples, the remote access interface circuitry 210 is instantiated by programmable circuitry executing remote access interface instructions and/or configured to perform operations such as those represented by the flowchart of FIG. 3.

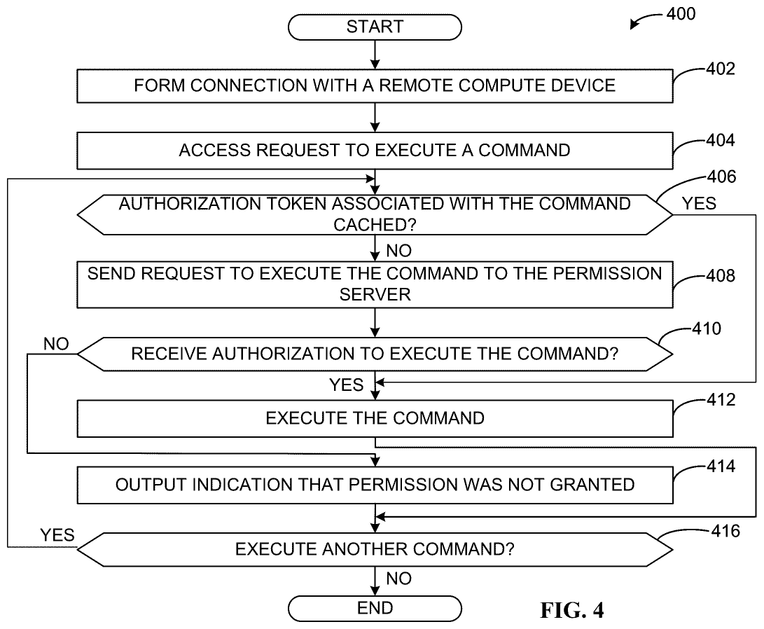

In some examples, the local access manager circuitry 122 includes means for remote interfacing. For example, the means for remote interfacing may be implemented by the remote access interface circuitry 210. In some examples, the remote access interface circuitry 210 may be instantiated by programmable circuitry such as the example programmable circuitry 712 of FIG. 7. For instance, the remote access interface circuitry 210 may be instantiated by the example microprocessor 800 of FIG. 8 executing machine executable instructions such as those implemented by at least blocks 404, 406, 414 of FIG. 4. In some examples, the remote access interface circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the remote access interface circuitry 210 may be instantiated by any other combination of hardware, software, and/or firmware. For example, the remote access interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The network interface circuitry 212 interfaces with the network 110 and can exchange communications with the identity and access management server 106 and the remote compute device 102. For example, the network interface circuitry 212 can be used for the communications required to operate the remote interface 116 with the remote compute device 102 via the network 110. In some examples, the network interface circuitry 212 interfaces the identity and access management server 106 to request authorization to execute a command sent via the remote interface 116. In some examples, the network interface circuitry 212 is instantiated by programmable circuitry executing network interface instructions and/or configured to perform operations such as those represented by the flowchart of FIG. 4.

In some examples, the local access manager circuitry 122 includes means for interfacing with a network. For example, the means for interfacing with a network may be implemented by the network interface circuitry 212. In some examples, the network interface circuitry 212 may be instantiated by programmable circuitry such as the example programmable circuitry 712 of FIG. 7. For instance, the network interface circuitry 212 may be instantiated by the example microprocessor 800 of FIG. 8 executing machine executable instructions such as those implemented by at least blocks 402, 408, 410 of FIG. 4. In some examples, the network interface circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the network interface circuitry 212 may be instantiated by any other combination of hardware, software, and/or firmware. For example, the network interface circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The local system interface circuitry 214 interfaces with the systems and applications of the local compute device 104. The local system interface circuitry 214 can execute commands on the local compute device 104. For example, the local system interface circuitry 214 can access and/or modify one or more of the local files 118. In some examples, the local system interface circuitry 214 can execute one or more of the local applications 120. In some examples, the local system interface circuitry 214 is instantiated by programmable circuitry executing local system interface instructions and/or configured to perform operations such as those represented by the flowchart of FIG. 4.

In some examples, the local access manager circuitry 122 includes means for executing commands on a compute device. For example, the means for executing commands on a compute device may be implemented by the local system interface circuitry 214. In some examples, the local system interface circuitry 214 may be instantiated by programmable circuitry such as the example programmable circuitry 712 of FIG. 7. For instance, the local system interface circuitry 214 may be instantiated by the example microprocessor 800 of FIG. 8 executing machine executable instructions such as those implemented by at least blocks 412 of FIG. 7. In some examples, the local system interface circuitry 214 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the local system interface circuitry 214 may be instantiated by any other combination of hardware, software, and/or firmware. For example, the local system interface circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the local access manager circuitry 122 of FIG. 1 is illustrated in FIG. 2B, one or more of the elements, processes, and/or devices illustrated in FIG. 2B may be combined, divided, re-arranged, omitted, eliminated, and/or implemented in any other way. Further, the example remote access interface circuitry 210, the example network interface circuitry 212, the example local system interface circuitry 214, and/or, more generally, the example local access manager circuitry 122 of FIG. 2B, may be implemented by hardware alone or by hardware in combination with software and/or firmware. Thus, for example, any of the example remote access interface circuitry 210, the example network interface circuitry 212, the example local system interface circuitry 214, and/or, more generally, the example local access manager circuitry 122 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example local access manager circuitry 122 of FIG. 2B may include one or more elements, processes, and/or devices in addition to, or instead of, those illustrated in FIG. 2B, and/or may include more than one of any or all of the illustrated elements, processes and devices.

FIG. 2C is a block diagram of an example implementation of the permission manager circuitry 124 of FIG. 1 to manage the identities of users of the compute devices 102, 104, grant permissions to form connections therebetween, and to grant access the local files 118 and the local applications 120 via the remote interface 116. In the illustrated example of FIG. 2C, the permission manager circuitry 124 includes example network interface circuitry 216, example permission assessor circuitry 218, and example response generator circuitry 220. The permission manager circuitry 124 of FIG. 2C may be instantiated (e.g., creating an instance of, bring into being for any length of time, materialize, implement, etc.) by programmable circuitry such as a Central Processor Unit (CPU) executing first instructions. Additionally or alternatively, the permission manager circuitry 124 of FIG. 2C may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2C may, thus, be instantiated at the same or different times. Some or all of the circuitry of FIG. 2C may be instantiated, for example, in one or more threads executing concurrently on hardware and/or in series on hardware. Moreover, in some examples, some or all of the circuitry of FIG. 2C may be implemented by microprocessor circuitry executing instructions and/or FPGA circuitry performing operations to implement one or more virtual machines and/or containers.

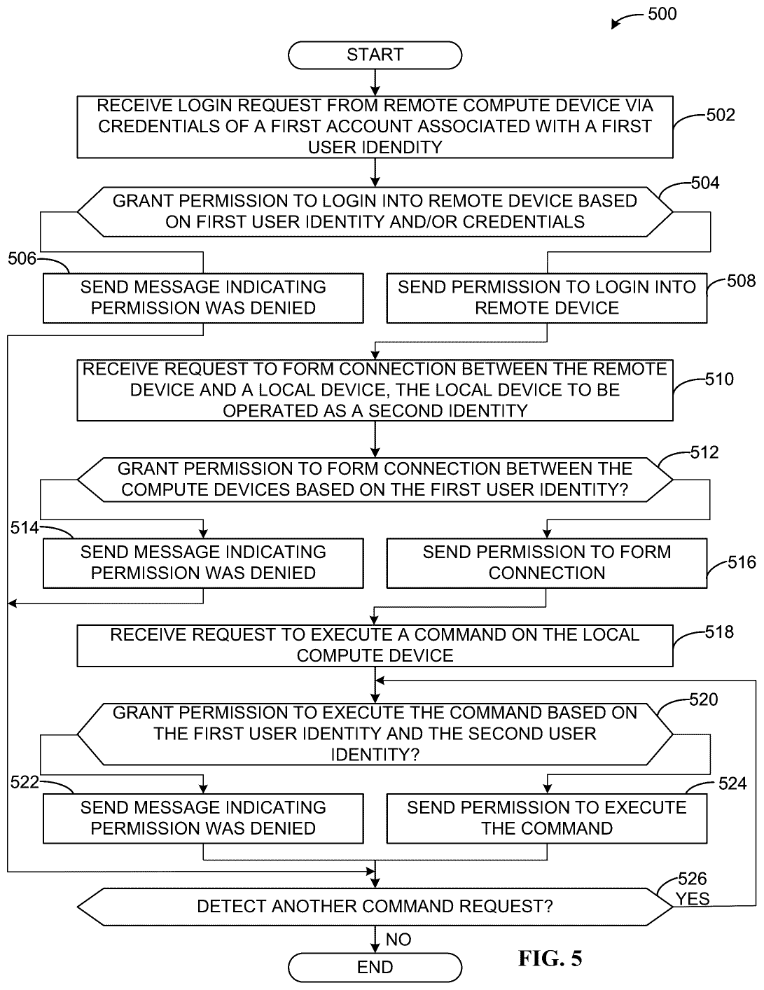

The network interface circuitry 216 interfaces with the network 110 and can exchange communications with the remote compute device 102 and the local compute device 104. For example, the network interface circuitry 216 exchanges the communications required to verify an account is permitted to access the remote compute device 102. In some examples, the network interface circuitry 216 exchanges communications to verify a connection between the devices 102, 104 via the remote interface 116 is permitted. In some examples, the network interface circuitry 216 exchanges communications to verify a command requested by the remote compute device 102 to be executed on the local compute device 104 via the remote interface 116 is permitted. In some examples, the network interface circuitry 216 is instantiated by programmable circuitry executing network interface instructions and/or configured to perform operations such as those represented by the flowchart of FIG. 5.

In some examples, the permission manager circuitry 124 includes means for interfacing with a network. For example, the means for interfacing with a network may be implemented by the network interface circuitry 216. In some examples, the network interface circuitry 216 may be instantiated by programmable circuitry such as the example programmable circuitry 712 of FIG. 7. For instance, the network interface circuitry 216 may be instantiated by the example microprocessor 800 of FIG. 8 executing machine executable instructions such as those implemented by at least blocks 502, 510, 518, 526 of FIG. 5. In some examples, the network interface circuitry 216 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the network interface circuitry 216 may be instantiated by any other combination of hardware, software, and/or firmware. For example, the network interface circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The permission assessor circuitry 218 determines if the remote compute device 102 is permitted to take actions based on the identity (e.g., a first identity, etc.) associated with the account operating the remote device 104 and/or the identity being impersonated by the remote interface 116 (e.g., the second identity, etc.). For example, the permission assessor circuitry 218 can determine whether to grant permission for an account to access the remote compute device 102. In some such examples, the permission assessor circuitry 218 can query the identity database 128 to determine if the credentials of the first account are correct. Additionally or alternatively, the permission assessor circuitry 218 can query the policies database to determine, based on the first identity, if the first account can log in to the remote compute device 102.

In some examples, the permission assessor circuitry 218 can determine whether permission is to be granted to form a connection between the compute devices 102, 104. For example, the permission assessor circuitry 218 can query the policies database 126 and/or the identity database 128 to determine, based on the first identity, if the first account is authorized to form a connection between the compute devices 102, 104. Additionally or alternatively, the permission assessor circuitry 218 can further determine if the first user account is authorized to form the connection based on an attribute of the local compute device 104, a communication protocol used to form the connection, a time of the connection request, and/or any other suitable criteria.

In some examples, the permission assessor circuitry 218 can determine if permission is to be granted to execute the command based on the first user identity and the second user identity. For example, the permission assessor circuitry 218 can query the policies database 126 and/or the identity database 128 to determine, based on the first identity and the second identity, if the first account is authorized to execute the first command via the remote interface 116 on the local compute device 104. Additionally or alternatively, the permission assessor circuitry 218 can further determine if the first user account is authorized to form the connection based on an attribute of the local compute device 104, a role of the account associated with the first identity, a role of the account associated with the second identity, an attribute of the remote compute device 102, an attribute of the local files 118, and/or the local applications 120 associated with the command (e.g., an encryption of the local files 118, a protection ring associated with the local files 118 and/or local applications 120, etc.), an attribute of the command (e.g., a command to export ones of the local files 118 to the remote compute device 102 can be held to higher security levels, and/or a protocol used by the first account to access the remote compute device. In some examples, the permission assessor circuitry 218 is instantiated by programmable circuitry executing permission assessor instructions and/or configured to perform operations such as those represented by the flowchart of FIG. 5.

In some examples, the permission manager circuitry 124 includes means for determining whether an action is permitted. For example, the means for determining whether an action is permitted may be implemented by the permission assessor circuitry 218. In some examples, the permission assessor circuitry 218 may be instantiated by programmable circuitry such as the example programmable circuitry 712 of FIG. 7. For instance, the permission assessor circuitry 218 may be instantiated by the example microprocessor 800 of FIG. 8 executing machine executable instructions such as those implemented by at least blocks 504, 510, 512 of FIG. 5. In some examples, the permission assessor circuitry 218 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the permission assessor circuitry 218 may be instantiated by any other combination of hardware, software, and/or firmware. For example, the permission assessor circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The response generator circuitry 220 generates a response to a request for permission to take an action based on an output of the permission assessor circuitry 218. For example, the response generator circuitry 220 can generate an indication that an action (e.g., accessing the remote compute device 102, forming a connection between the devices 102, 104, executing a command via the remote interface 116, etc.) is permitted. In some examples, the indication can be transmitted by the network interface circuitry 216 to the remote compute device 102 and/or the local compute device 104 indicating that such an action is permitted. In other examples, the response generator circuitry 220 can generate and/or send a response indicating that the requested action is not authorized (e.g., not permitted, etc.). In some examples, the response generator circuitry 220 is instantiated by programmable circuitry executing response generator instructions and/or configured to perform operations such as those represented by the flowcharts of FIG. 5.

In some examples, the permission manager circuitry 124 includes means for generating a response to permission request. For example, the means for generating a response to permission request may be implemented by the response generator circuitry 220. In some examples, the response generator circuitry 220 may be instantiated by programmable circuitry such as the example programmable circuitry 712 of FIG. 7. For instance, the response generator circuitry 220 may be instantiated by the example microprocessor 800 of FIG. 8 executing machine executable instructions such as those implemented by at least blocks 506, 508, 514, 516, 522, 524 of FIG. 5. In some examples, the response generator circuitry 220 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the response generator circuitry 220 may be instantiated by any other combination of hardware, software, and/or firmware. For example, the response generator circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the permission manager circuitry 124 of FIG. 1 is illustrated in FIG. 2C, one or more of the elements, processes, and/or devices illustrated in FIG. 2C may be combined, divided, re-arranged, omitted, eliminated, and/or implemented in any other way. Further, the example network interface circuitry 216, the example permission assessor circuitry 218, the example response generator circuitry 220 and/or, more generally, the example permission manager circuitry 124 of FIG. 2C may be implemented by hardware alone or by hardware in combination with software and/or firmware. Thus, for example, any of the example network interface circuitry 216, the example permission assessor circuitry 218, the example response generator circuitry 220, and/or, more generally, the example permission manager circuitry 124, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example permission manager circuitry 124 of FIG. 2C may include one or more elements, processes, and/or devices in addition to, or instead of, those illustrated in FIG. 2C, and/or may include more than one of any or all of the illustrated elements, processes and devices.

A flowchart representative of example machine readable instructions, which may be executed by programmable circuitry to implement and/or instantiate the remote access manager circuitry 108 of FIG. 2A and/or representative of example operations which may be performed by programmable circuitry to implement and/or instantiate the remote access manager circuitry 108 of FIG. 2A is shown in FIG. 3. A flowchart representative of example machine readable instructions, which may be executed by programmable circuitry to implement and/or instantiate the local access manager circuitry 122 of FIG. 2B and/or representative of example operations which may be performed by programmable circuitry to implement and/or instantiate the local access manager circuitry 122 of FIG. 2B is shown in FIG. 4. A flowchart representative of example machine readable instructions, which may be executed by programmable circuitry to implement and/or instantiate the permission manager circuitry 124 of FIG. 2C and/or representative of example operations which may be performed by programmable circuitry to implement and/or instantiate the permission manager circuitry 124 of FIG. 2C is shown in FIG. 5. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3, 4 and 5, many other methods of implementing the example remote access manager circuitry 108, the local access manager circuitry 122, and the permission manager circuitry 124, respectively, may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or compute devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a compute device and/or other machine. For example, the machine readable instructions may be stored in multiple parts, which are individually compressed, encrypted, and/or stored on separate compute devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular compute device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to form a connection with the local compute device 104 of FIG. 1 and to execute operations thereon. The example machine-readable instructions and/or the example operations 300 of FIG. 3 begin at block 302, at which the user interface circuitry 202 accesses a login request with credentials of a first account. For example, the user interface circuitry 202 can receive credentials (e.g., a password, a code, an account name, a user name, a biometric indicator, etc.) associated with an account from the user interface 109. At block 304, the network interface circuitry 206 sends the credentials to the identity and access management server 106 (e.g., the permission manager circuitry 124, etc.). For example, the network interface circuitry 206 can send the credentials via a wireless connection (e.g., a LAN, a WAN, the internet, etc.) and/or a wired connection. In some examples, the network interface circuitry 206 can hash and/or encrypt the credentials during the execution of block 302.

At block 306, the login manager circuitry 204 determines whether permission to log in was received. For example, the login manager circuitry 204 can determine whether the identity and access management server 106 sent permission (e.g., an authorization, etc.) to the remote compute device 102 (e.g., an authorization associated with the execution of block 508 of the operations 500 of FIG. 5, etc.) or whether the identity and access management server 106 sent a message denying permission to log in to the remote compute device 102 (e.g., a message associated with the execution of block 506 of the operations 500 of FIG. 5, etc.). If the login manager circuitry 204 determines permission to log in was received, the operations 300 advance to block 308. If the login manager circuitry 204 determines permission to log in was not received, the operations 300 end.

At block 308, the login manager circuitry 204 grants access to the remote compute device to a first account having a first identity. For example, the login manager circuitry 204 can grant access to the remote compute device 102 to a first account associated with the credentials received during the execution of block 304. In some examples, the login manager circuitry 204 can generate a data structure that indicates the first identity associated the first account and store the data structure in a memory of the remote compute device 102.

At block 310, the user interface circuitry 202 accesses a request to form a connection with the local compute device 104 to operate the local compute device 104 with a second user identity. For example, the user interface circuitry 202 can receive a request from the user interface 109 to form a connection with the local compute device 104. At block 312, the network interface circuitry 206 sends the request to form a connection with the local compute device 104 to the identity and access management server 106 (e.g., the permission manager circuitry 124, etc.). For example, the network interface circuitry 206 can send the request to form the connection via a wireless connection (e.g., a LAN, a WAN, the internet, etc.) and/or a wired connection.

At block 314, the network interface circuitry 206 determines if authorization to form a connection was received from the identity and access management server 106. For example, the network interface circuitry 206 can determine whether the identity and access management server 106 sent permission (e.g., an authorization, etc.) to form a connection between the devices 102, 104 (e.g., an authorization associated with the execution of block 514 of the operations of FIG. 5, etc.) or whether the identity and access management server 106 sent a message denying permission to form a connection between the devices 102, 104 (e.g., a message associated with the execution of block 516 of the operations of FIG. 5, etc.). If the network interface circuitry 206 determines permission to form a connection with the local compute device was received, the operations 300 advance to block 316. If the network interface circuitry 206 determines permission to form a connection with the local compute device was not received, the operations 300 end.

At block 316, the network interface circuitry 206 forms a connection with the local compute device 104. For example, the network interface circuitry 206 can form a TCP/IP connection with the local compute device 104 and/or initiate the remote interface 116 of FIG. 1. In other examples, the network interface circuitry 206 can form a connection with the local compute device 104 via any other suitable communication protocol. In some examples, the connection with the local compute device 104 permits a user of the remote compute device 102 to execute commands on the local compute device via a subset of privileges associated with a user of the local compute device. In some examples, the connection between the devices 102, 104 includes a data structure that indicates the identity associated with the account that is logged in to the remote compute device 102 (e.g., the account that was granted access during the execution of block 308, etc.). Example operations for executing commands via the connection between the remote compute device 102 and the local compute device 104 are described below in conjunction with FIG. 4.

At block 318, the memory interface circuitry 208 determines if a command authorization token is to be cached. For example, the memory interface circuitry 208 can cache (e.g., save, etc.) a command authorization token (e.g., an OAuth 2.0 token, etc.) in a memory associated with the remote compute device 102 and/or the local compute device 104. If the memory interface circuitry 208 determines a command authorized token is to be cached, the operations 500 advance to block 320. If the memory interface circuitry 208 determines a command authorized token is not to be cached, the operations 500 advance to block 322. At block 320, the memory interface circuitry 208 caches a command authorization token. For example, the memory interface circuitry 208 can store the command token in a memory associated with the remote compute device 102, the entity 103, and/or the local compute device 104. In some such examples, the memory interface circuitry 208 can store the command authorization token in a local memory (e.g., the local memory 713 of FIG. 7, etc.), in a volatile memory (e.g., the volatile memory 714 of FIG. 7, etc.), in a non-volatile memory (e.g., the non-volatile memory 716 of FIG. 7, etc.), and/or in a mass storage device (e.g., the mass storage device 728 of FIG. 7, etc.).

At block 322, the memory interface circuitry 208 determines if local files are to be saved. For example, the memory interface circuitry 208 can determine a command to export files from the local compute device 104 to the remote compute device 102 that has been executed by the remote interface 116 and/or the local compute device 104. If the memory interface circuitry 208 determines a local files are to be saved, the operations 300 advance to block 324. If the memory interface circuitry 208 determines a command authorized token is not to be cached, the operations 300 advance to block 326. At block 324, the memory interface circuitry 208 saves local files on a memory associated with the remote compute device.

At block 326, the network interface circuitry 206 determines if the connection between the devices 102, 104 is to be terminated. For example, the network interface circuitry 206 can determine whether the connection is to be terminated based on user input from the user interface 109. Additionally or alternatively, the network interface circuitry 206 can determine whether to terminate the connection after a fixed period of time has elapsed. Additionally or alternatively, the network interface circuitry 206 can determine whether to terminate the connection based on a communication with the identity and access management server 106. If the network interface circuitry 206 determines the connection is to be terminated, the operations 300 advance to block 328. If the network interface circuitry 206 determines the connection is not to be terminated, the operations 300 end. At block 328, the network interface circuitry 206 terminates the connection between the devices 102, 104. For example, the network interface circuitry 206 can close (e.g., disable, deactivate, cease operating, etc.) the remote interface 116 and connection established during the execution of block 316.

FIG. 4 is a flowchart representative of example machine readable instructions and/or example operations 400 that may be executed, instantiated, and/or performed by programmable circuitry to form a connection with the remote compute device 102 of FIG. 1, perform operations via the local files 118 and the local applications 120, and manage permission thereto via communications with the identity and access management server 106. The example machine-readable instructions and/or the example operations 400 of FIG. 4 begin at block 402, at which the network interface circuitry 212 forms a connection between the local compute device 104 and the remote compute device 102. For example, the local compute device 104 and/or the local access manager circuitry 122 can open the remote interface 116. In some examples, the execution of block 402 occurs immediately after and/or concurrently with the execution of block 316 of the operations 300 of FIG. 3.

At block 404, the remote access interface circuitry 210 accesses a request to execute a command. For example, the remote access interface circuitry 210 can receive a command from the remote compute device 102 via the remote interface 116 to execute a command on the local compute device 104. In some examples, the remote access interface circuitry 210 can receive a command to access or modify one or more of the local files 118 and/or execute one or more of the local applications 120. In some examples, the remote access interface circuitry 210 can receive a command to export one or more of the local files 118 to the remote compute device 102.

At block 406, the remote access interface circuitry 210 determines if a command authorization token associated with the command has been cached. For example, the remote access interface circuitry 210 can determine if a command authorization token that is applicable to the command has been saved in a memory (e.g., a cache, etc.) associated with one or more of the devices 102, 104. For example, the remote access interface circuitry 210 can determine if an applicable command token was cached during an execution of block 320 of the operations 300. If the remote access interface circuitry 210 determines an authorization token associated with the command is cached, the command is authorized based on a previous determination of the identity and access management server 106, and the operations 400 advance to block 412. If the remote access interface circuitry 210 determines an authorization token associated with the command is not cached, the command has not been authorized based on a previous determination of the identity and access management server 106, and the operations 400 advance to block 408.

At block 408, the network interface circuitry 212 sends a request to execute the command to the identity and access management server 106. For example, the network interface circuitry 212 can send, via a network communication, the request to the identity and access management server 106. In some examples, the request can include attributes of the command (e.g., the type of the command, the affected ones of the local files 118, the affected ones of the local applications 120, a timestamp associated with the commands, etc.), an identity being impersonated by the remote interface 116, and/or an identity associated with the account operating the remote compute device 102.

At block 410, the network interface circuitry 212 determines if authorization to execute the command has been received. For example, the network interface circuitry 212 can determine whether the identity and access management server 106 sent permission (e.g., an authorization, etc.) to execute the command (e.g., an authorization associated with the execution of block 522 of the operations 500 of FIG. 5, etc.) or whether the identity and access management server 106 sent a message denying permission to execute the command (e.g., a message associated with the execution of block 524 of the operations 500 of FIG. 5, etc.). If the network interface circuitry 206 determines permission to execute the command was received, the operations 400 advance to block 412. If the network interface circuitry 206 determines permission to execute the command was not received, the operations 400 advance to block 414. At block 412, the local system interface circuitry 214 executes the command. For example, the local system interface circuitry 214 can modify, export, and/or access ones of the local files 118 and/or the local applications 120 in accordance with the command received during the execution of block 404.

At block 414, the remote access interface circuitry 210 outputs an indicate that permission was not granted. For example, the remote access interface circuitry 210 can cause the user interface 109 of the remote compute device 102 to output an indication that the permission to execute the command was not granted by the identity and access management server 106. In some such examples, the output can be a visual output, an audio output, and/or a tactile output.

At block 416, the remote access interface circuitry 210 determines if another command is to be executed. For example, the remote access interface circuitry 210 can determine whether another command is to be executed based on an input from the remote compute device 102 (e.g. if another command has been received from the remote compute device 102, etc.). In other examples, the execution of block 416 can be repeated until the connection between the devices 102, 104 is terminated (e.g., via the execution of block 328 of FIG. 3, etc.).

FIG. 5 is a flowchart representative of example machine readable instructions and/or example operations 500 that may be executed, instantiated, and/or performed by programmable circuitry to manage the identities of users of the compute devices 102, 104, grant permissions to form connections therebetween, and to grant access to the local files 118 and the local applications 120 via the remote interface 116. In the illustrated example of FIG. 5, the blocks 502-526 are presented sequentially. It should be appreciated that the execution of one or more of the blocks 502-526 can be prompted by actions of the remote access manager circuitry 108 (e.g., the operations 300 of FIG. 3, etc.) and/or the actions of the local access manager circuitry 122 (e.g., the operations 400 of FIG. 4, etc.).

The example machine-readable instructions and/or the example operations 500 of FIG. 5 begin at block 502, the network interface circuitry 216 receives a login request from the remote compute device 102 via credentials associated with a first account associated with a first identity. For example, the network interface circuitry 216 can receive the log-in request sent by the network interface circuitry 206 if the remote access manager circuitry 108 during the execution of block 306. At block 504, the permission assessor circuitry 218 determines if permission is to be granted for the first account to log in to the remote compute device based on the first user identity and/or the credentials. For example, the permission assessor circuitry 218 can query the identity database 128 to determine if the credentials of the first account are correct. Additionally or alternatively, the permission assessor circuitry 218 can query the policies database to determine, based on the first identity, if the first account can login into the remote compute device 102. If the permission assessor circuitry 218 determines permission is not to be granted (e.g., permission is to be denied, etc.) for the first account to log in to the remote compute device 102, the operations 500 advance to block 506. If the permission assessor circuitry 218 determines permission is to be granted for the first account to log in to the remote compute device 102, the operations 500 advance to block 508.

At block 506, the response generator circuitry 220 can send a message indicating permission was denied. For example, the response generator circuitry 220 can send a string to the remote access manager circuitry 108 indicating that permission to login into the remote manager circuitry 108 has been denied. In other examples, the response generator circuitry 220 can send any other suitable type of response to the remote access manager circuitry 108. At block 508, the response generator circuitry 220 sends permission to login into the remote device. For example, the response generator circuitry 220 can send an authorization token to the remote compute device 102 authorizing the first account to login into the remote compute device 102.

At block 510, the network interface circuitry 216 receives a request to form the connection between the remote device and the local compute device 104, the connection enabling the second compute device 104 to be operated as a second identity. For example, the network interface circuitry 216 can receive the connection request sent by the network interface circuitry 206 during the execution of block 312 of the operations 300 of FIG. 3. At block 512, the permission assessor circuitry 218 determines if permission is to be granted for the form a connection between the compute devices 102, 104. For example, the permission assessor circuitry 218 can query the policies database 126 and/or the identity database 128 to determine, based on the first identity, if the first account is authorized to form a connection between the compute devices 102, 104. Additionally or alternatively, the permission assessor circuitry 218 can further determine if the first user account is authorized to form the connection based on an attribute of the local compute device 104, a communication protocol used to form the connection, a time of the connection request, and/or any other suitable criteria. If the permission assessor circuitry 218 determines permission is not to be granted (e.g., permission is to be denied, etc.) for the first account to form a connection between the devices 102, 104, the operations 500 advance to block 514. If the permission assessor circuitry 218 determines permission is to be granted for the first account to log in to the remote compute device 102, the operations 500 advance to block 516.

At block 514, the response generator circuitry 220 can send a message indicating permission was denied. For example, the response generator circuitry 220 can send a string to the remote access manager circuitry 108 indicating that permission to form a connection between the devices 102, 104 was denied. In other examples, the response generator circuitry 220 can send any other suitable type of response to the remote access manager circuitry 108. At block 516, the response generator circuitry 220 sends permission to form a connection between the devices 102, 104 to the remote compute device 102. For example, the response generator circuitry 220 can send an authorization token to the remote compute device 102 authorizing a connection between the devices 102, 104 and the initiation of the remote interface 116.

At block 518, the network interface circuitry 216 receives a request to execute a command on the local compute device 104. For example, the network interface circuitry 216 can receive the command request sent by the network interface circuitry 212 during the execution of block 408 of the operations 400 of FIG. 4.

At block 520, the permission assessor circuitry 218 determines if permission is to be granted to execute the command based on the first user identity and the second user identity. For example, the permission assessor circuitry 218 can query the policies database 126 and/or the identity database 128 to determine, based on the first identity and the second identity, if the first account is authorized to execute the first command via the remote interface 116 on the local compute device 104. Additionally or alternatively, the permission assessor circuitry 218 can further determine if the first user account is authorized to form the connection based on an attribute of the local compute device 104 an attribute of the local compute device, an attribute of the local files 118, and/or the local applications 120 associated with the command (e.g., an encryption of the local files 118, a protection ring associated with the local files 118 and/or local applications 120, etc.), an attribute of the command (e.g., a command to export ones of the local files 118 to the remote compute device 102 can be held to higher security levels, and/or a protocol used by the first account to access the remote compute device. If the permission assessor circuitry 218 determines permission is not to be granted (e.g., permission is to be denied, etc.) to execute the command, the operations 500 advance to block 522. If the permission assessor circuitry 218 determines permission is to be granted to execute the command, the operations 500 advance to block 524.

At block 522, the response generator circuitry 220 can send a message indicating permission was denied. For example, the response generator circuitry 220 can send a string to the remote access manager circuitry 108 indicating that permission to form a connection between the devices 102, 104 was denied. In other examples, the response generator circuitry 220 can send any other suitable type of response to the remote interface 116 and/or the local access manager circuitry 122.

At block 524, the response generator circuitry 220 sends permission to execute the command to the local compute device 104. For example, the response generator circuitry 220 can send an authorization token to one or both of the devices 102, 104 authorizing the execution of the command In some such examples, the token sent by the response generator circuitry 220 can be saved by one or both of the devices 102, 104 and used to authorize the execution of commands similar to the command considered during the execution of block 520. In some examples, the response generator circuitry 220 can generate a permission that is tailored to the scope of the request command. For example, if the command request (e.g., the task, etc.) is retrieve a file artifact (e.g., one of the local files 118, etc.), the response generator circuitry 220 could send a permission a read-only permission to view the file artifact (e.g., grant access to secure copy (SCP) command line interface (CLI), etc.).

At block 526, the network interface circuitry 216 determines if another command request has been requested. For example, the network interface circuitry 216 can determine if the local access manager circuitry 122 has sent another authorization request to the identity and access management server 106 to execute a command. If the network interface circuitry 216 determines another command request has been received, the operations 500 return to block 520. If the network interface circuitry 216 determines another command request has not been received, the operations 500 end.

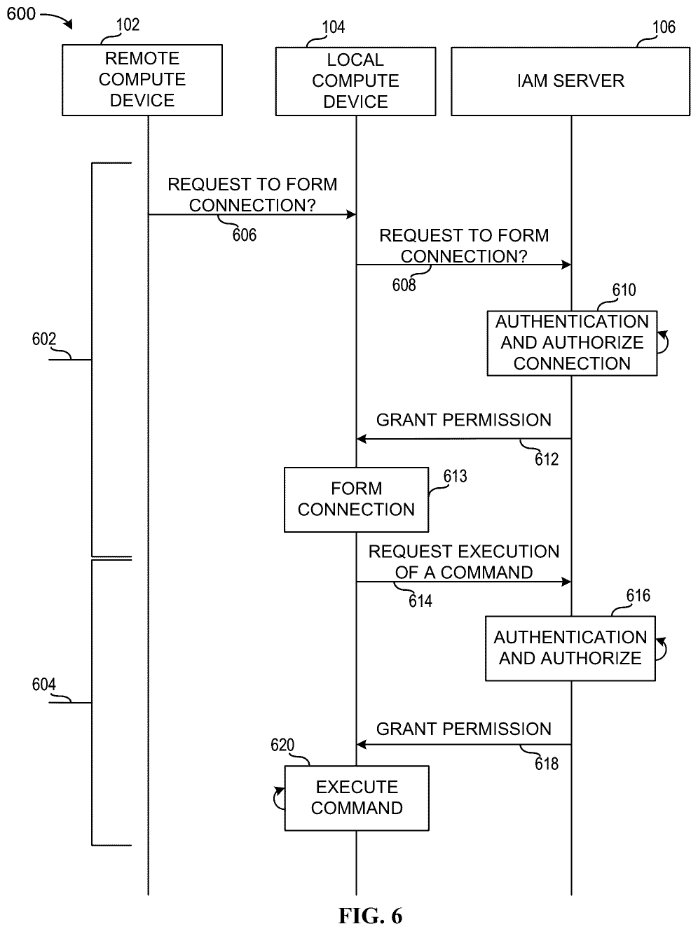

Referring now to FIG. 6, FIG. 6 is a communication diagram representing example communications 600 exchanged between the remote compute device 102, the local compute device 104, and the identity and access management server 106 of FIG. 1. In some examples, the operations conducted by the remote compute device 102 are conducted by the remote access manager circuitry 108, the operations conducted by the local compute device 104 are conducted by the local access manager circuitry 122, and/or the identity and access management server 106 are conducted by the permission manager circuitry 124. The example communications 600 include example connection establishing communications 602 and example command executing communications 604. In the illustrated example of FIG. 6, the connection establishing communications 602 begins when the remote compute device 102 sends an example first request 606 to establish communications between the remote compute device 102 and the local compute device 104. In some examples, the first request 606 can be a request sent by the network interface circuitry 206 during the execution of block 312 of the operations 300 of FIG. 3. In the illustrated example of FIG. 6, after receiving the first request 606, the local compute device 104 can send an example second request 608 to the identity and access management server 106 to request permission to form a connection between the devices 102, 104. In other examples, the second request 608 is absent and the first request 606 can be sent directly to the identity and access management server 106.

After receiving the second request 608 and/or the first request 606, the identity and access management server 106 makes an example first authentication determination 610. For example, the identity and access management server 106 can make the first authentication determination 610 based on the identity of the account operating the remote compute device 102, the local compute device 104, and/or any other suitable criteria (e.g., an identity that is to be impersonated during remote operation of the local compute device, a time of day, a protocol of connection to be used to form the connection, etc.). After the first authentication determination 610, the identity and access management server 106 can send an example first permission 612 to the local compute device 104 that indicates a connection between the devices 102, 104 is authorized (e.g., permitted, etc.). In other examples, the identity and access management server 106 can send an indication that the connection is not permitted to be formed, which terminates the connection establishing communications 602 and the communications 600. After receiving the first permission 612, the local compute device 104 and the remote compute device 102 can form (e.g., establish, etc.) an example connection 613 therebetween. For example, the remote interface 116 can be established on the local compute device 104, which enables the remote compute device 102 to execute instructions on the local compute device 104. In some examples, the remote interface 116 includes a data structure (e.g., an indication, etc.) that is indicative of the identity of the account operating the remote compute device 102.

After the connection 613 has been established, the command executing communications 604 can occur. In the illustrated example of FIG. 6, an example third request 614 can be sent from the local compute device 104 to the identity and access management server 106. In some examples, the third request 614 can occur in response to a user input to the remote compute device 102, which is sent via a request (not illustrated) to the remote compute device 102 via the connection 613. In some examples, the user input can be liveness test (e.g., a verification that the remote compute device 102 is not a bot, etc.), such as providing a user credential, a biometric input and/or any other suitable liveness test. After receiving the third request 614, the identity and access management server 106 makes an example second authentication determination 616. For example, the identity and access management server 106 can make the second authentication determination 616 based on the identity of the account operating the remote compute device 102 (e.g., a first identity, etc.), the identity to be impersonated on the local compute device 104 (e.g., a second identity, etc.), and/or other criteria (e.g., a time of day, a role of the account of the remote compute device, the affected ones of the local files 118 and/or the local applications 120 of the local compute device 104, the method of accessing the affected ones of the local files 118 and/or the local applications 120, a protocol of connection to be used to form the connection, etc.).

After the second authentication determination 616, the identity and access management server 106 can send an example second permission 618 to the local compute device 104 that indicates the command requested by the third request 614 is permitted. In other examples, the identity and access management server 106 can send an indication that the command is not permitted to be executed. In some examples, the second permission 618 can include a command authorization token (e.g., an OAuth 2.0, etc.). In some examples, the command authorization token can authorize repeated instances of the command associated with the third request 614 and/or commands similar to the command associated with the second request without further communications with the identity and access management server 106. In some examples, the command authorization token can be time-sensitive and expire after a set amount of time and/or when the connection 613 is terminated. After receiving second permission 618, the local compute device 104 can perform the command execution 620, where the command requested by the third request 614 is executed. After the execution 620, additional commands can be performed via a set of communications similar to the command executing communications 604.

FIG. 7 is a block diagram of an example programmable circuitry platform 700 structured to execute and/or instantiate the example machine-readable instructions and/or the example operations of FIGS. 4-6 to implement the local access manager circuitry 122 of FIG. 2A, the local access manager circuitry 122, and/or the permission manager circuitry 124 of FIG. 2C. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a Blu-ray player, a gaming console, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. For example, the programmable circuitry 712 can implement the components of the remote access manager circuitry 108 (e.g., the user interface circuitry 202, the login manager circuitry 204, the network interface circuitry 206, and/or the memory interface circuitry 208, etc.), the components of the local access manager circuitry 122 (e.g., remote access interface circuitry 210, the network interface circuitry 212, and/or the local system interface circuitry 214, etc.), and/or the components of the permission manager circuitry 124 (e.g., the network interface circuitry 216, the permission assessor circuitry 218, and/or the response generator circuitry 220, etc.).

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., compute devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4, 5 and/or 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4, 5, and/or 6 to effectively instantiate the circuitry of FIGS. 2A, 2B and/or 2C, respectively, as logic circuits to perform operations corresponding to those machine readable instructions. In some such examples, the circuitry of FIGS. 2A, 2B and/or 2C is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4, 5, and/or 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry 816 (sometimes referred to as an ALU), a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 4, 5 and/or 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4, 5 and/or 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4, 5 and/or 6. As such, the FPGA circuitry 900 may be configured and/or structured to effectively instantiate some or all of the operations/functions corresponding to the machine readable instructions of the flowcharts of FIGS. 4, 5 and/or 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4, 5 and/or 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4, 5 and/or 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4, 5 and/or 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 4, 5 and/or 6, and/or an ASIC may be configured and/or structured to perform third operation(s)/function(s) corresponding to a third portion of the machine readable instructions represented by the flowcharts of FIGS. 4, 5 and/or 6.

It should be understood that some or all of the circuitry of FIGS. 2A, 2B, and/or 2C may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIGS. 2A, 2B, and/or 2C may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIGS. 2A, 2B, and/or 2C may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

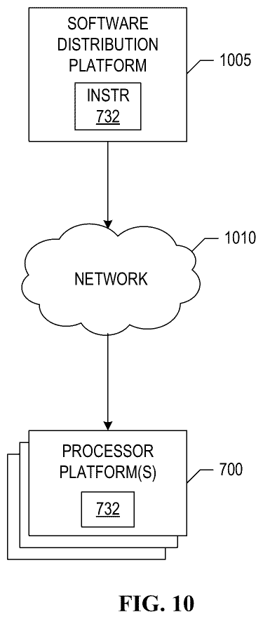

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other compute devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4, 5, and/or 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 4, 5, and/or 6, may be downloaded to the example programmable circuitry platform 700, which is to execute the machine readable instructions 732 to implement the remote access manager circuitry 108, the local access manager circuitry 122, and/or the permission manager circuitry 124, respectively. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed for secure remote operation of local compute devices. Disclosed systems, apparatus, articles of manufacture, and methods improve the efficiency of using a compute device by preventing authorized access to potential sensitive local resources. Examples disclosed herein mitigate privilege escalation of remote accessors of local resources. Examples disclosed herein facilitate the operation and debugging of local compute devices in entities that can include multiple tenants. Examples disclosed herein enable infrastructure as a service (IaaS) platforms by utilizing a centralized identity and access management server for all authorization. Disclosed systems, apparatus, articles of manufacture, and methods are accordingly directed to one or more improvement(s) in the operation of a machine such as a computer or other electronic and/or mechanical device.

Methods and apparatus for identity and access management on networked machines are disclosed herein. Further examples and combinations thereof include the following:

Example 1 includes a non-transitory machine readable storage medium comprising instructions to cause programmable circuitry to at least grant first permission to form a connection between a remote compute device and a local compute device based on a first identity of a first account, the connection to enable the first account to operate the local compute device via a subset of privileges of a second user, the second user associated with a second identity, access a request to execute a command on the remote compute device from the first account, and determine, based on the first identity of the first account and the second identity of the second user, whether second permission is to be granted to execute the command.

Example 2 includes the non-transitory machine readable storage medium of any preceding example, wherein the instructions further cause the programmable circuitry to determine whether to grant the second permission based on at least one (1) the local compute device, a (2) an attribute of the command, and (3) a protocol used by the first account to access the remote compute device.

Example 3 includes the non-transitory machine readable storage medium of any preceding example, wherein the instructions further cause the programmable circuitry to grant the first permission by granting the first account access to a first resource associated with a first protection ring, the command associated with a second resource associated with a second protection ring less privileged than the first protection ring.

Example 4 includes the non-transitory machine readable storage medium of any preceding example, wherein the command is a first command, the request is a first request, and the instructions further cause the programmable circuitry to access a second request to execute a second command to export data to the local compute device, and determine, based on the first identity of the first account and the second identity of the second user, whether a third permission is to be granted to execute the second command.

Example 5 includes the non-transitory machine readable storage medium of any preceding example, wherein the connection includes a data structure indicative of the first identity to the remote compute device.

Example 6 includes the non-transitory machine readable storage medium of any preceding example, wherein the instructions further cause the programmable circuitry to grant the second permission to execute the command by issuing a token to the local compute device, the token enabling the local compute device to access a resource associated with the command.

Example 7 includes the non-transitory machine readable storage medium of any preceding example, wherein the token is to be cached on the local compute device, the token expiring after a duration.

Example 8 includes an apparatus comprising network interface circuitry, machine readable instructions, and programmable circuitry to at least one of instantiate or execute the machine readable instructions to grant first permission to form a connection between a remote compute device and a local compute device based on a first identity of a first account, the connection to enable the first account to operate the local compute device via a subset of privileges of a second user, the second user associated with a second identity, access a request to execute a command on the remote compute device from the first account, and determine, based on the first identity of the first account and the second identity of the second user, whether second permission is to be granted to execute the command.

Example 9 includes the apparatus of any preceding example, wherein the programmable circuitry is further to determine whether to grant the second permission based on at least one (1) the local compute device, a (2) an attribute of the command, and (3) a protocol used by the first account to access the remote compute device.

Example 10 includes the apparatus of any preceding example, wherein the programmable circuitry is further to grant the first permission by granting the first account access to a first resource associated with a first protection ring, the command associated with a second resource associated with a second protection ring less privileged than the first protection ring.

Example 11 includes the apparatus of any preceding example, wherein the command is a first command, the request is a first request, and the programmable circuitry is further to access a second request to execute a second command to export data to the local compute device, and determine, based on the first identity of the first account and the second identity of the second user, whether a third permission is to be granted to execute the second command.

Example 12 includes the apparatus of any preceding example, wherein the connection includes a data structure indicative of the first identity to the remote compute device.

Example 13 includes the apparatus of any preceding example, wherein the instructions further cause the programmable circuitry to grant the second permission to execute the command by issuing a token to the interface, the token enabling the interface to access a resource associated with the command.

Example 14 includes the apparatus of any preceding example, wherein the token is to be cached on the local compute device, the token expiring after a duration.

Example 15 includes a method comprising granting first permission to form a connection between a remote compute device and a local compute device based on a first identity of a first account, the connection to enable the first account to operate the local compute device by impersonating a second user, the second user associated with a second identity, accessing a request to execute a command on the remote compute device from the first account, and determining, based on the first identity of the first account and the second identity of the second user, whether second permission is to be granted to execute the command.

Example 16 includes the method of any preceding example, further including determining whether to grant the second permission based on at least one (1) the local compute device, a (2) an attribute of the command, and (3) a protocol used by the first account to access the remote compute device.

Example 17 includes the method of example 15, further including granting the first permission by granting the first account access to a first resource associated with a first protection ring, the command associated with a second resource associated with a second protection ring less privileged than the first protection ring.

Example 18 includes the method of example 15, wherein the command is a first command, the request is a first request, and further including accessing a second request to execute a second command to export data to the local compute device, and determining, based on the first identity of the first account and the second identity of the second user, whether a third permission is to be granted to execute the second command.

Example 19 includes the method of example 15, wherein the connection includes a data structure indicative of the first identity to the remote compute device.

Example 20 includes the method of example 19, further including grant the second permission to execute the command by issuing a token to the local compute device, the token enabling the local compute device to access a resource associated with the command.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause programmable circuitry to at least:
grant first permission to form a connection between a remote compute device and a local compute device based on a first identity of a first account, the connection to enable the first account to operate the local compute device via a subset of privileges of a second user, the second user associated with a second identity;
access a request to execute a command on the remote compute device from the first account; and
determine, based on the first identity of the first account and the second identity of the second user, whether second permission is to be granted to execute the command.

2. The non-transitory machine readable storage medium of claim 1, wherein the instructions further cause the programmable circuitry to determine whether to grant the second permission based on at least one (1) the local compute device, a (2) an attribute of the command, and (3) a protocol used by the first account to access the remote compute device.

3. The non-transitory machine readable storage medium of claim 1, wherein the instructions further cause the programmable circuitry to grant the first permission by granting the first account access to a first resource associated with a first protection ring, the command associated with a second resource associated with a second protection ring less privileged than the first protection ring.

4. The non-transitory machine readable storage medium of claim 1, wherein the command is a first command, the request is a first request, and the instructions further cause the programmable circuitry to:
access a second request to execute a second command to export data to the local compute device; and
determine, based on the first identity of the first account and the second identity of the second user, whether a third permission is to be granted to execute the second command.

5. The non-transitory machine readable storage medium of claim 1, wherein the connection includes a data structure indicative of the first identity to the remote compute device.

6. The non-transitory machine readable storage medium of claim 5, wherein the instructions further cause the programmable circuitry to grant the second permission to execute the command by issuing a token to the local compute device, the token enabling the local compute device to access a resource associated with the command.

7. The non-transitory machine readable storage medium of claim 6, wherein the token is to be cached on the local compute device, the token expiring after a duration.

8. An apparatus comprising:
network interface circuitry;
machine readable instructions; and
programmable circuitry to at least one of instantiate or execute the machine readable instructions to:
grant first permission to form a connection between a remote compute device and a local compute device based on a first identity of a first account, the connection to enable the first account to operate the local compute device via a subset of privileges of a second user, the second user associated with a second identity;
access a request to execute a command on the remote compute device from the first account; and
determine, based on the first identity of the first account and the second identity of the second user, whether second permission is to be granted to execute the command.

9. The apparatus of claim 8, wherein the programmable circuitry is further to determine whether to grant the second permission based on at least one (1) the local compute device, a (2) an attribute of the command, and (3) a protocol used by the first account to access the remote compute device.

10. The apparatus of claim 8, wherein the programmable circuitry is further to grant the first permission by granting the first account access to a first resource associated with a first protection ring, the command associated with a second resource associated with a second protection ring less privileged than the first protection ring.

11. The apparatus of claim 8, wherein the command is a first command, the request is a first request, and the programmable circuitry is further to:
access a second request to execute a second command to export data to the local compute device; and
determine, based on the first identity of the first account and the second identity of the second user, whether a third permission is to be granted to execute the second command.

12. The apparatus of claim 8, wherein the connection includes a data structure indicative of the first identity to the remote compute device.

13. The apparatus of claim 12, wherein the instructions further cause the programmable circuitry to grant the second permission to execute the command by issuing a token to the interface, the token enabling the interface to access a resource associated with the command.

14. The apparatus of claim 13, wherein the token is to be cached on the local compute device, the token expiring after a duration.

15. A method comprising:
granting first permission to form a connection between a remote compute device and a local compute device based on a first identity of a first account, the connection to enable the first account to operate the local compute device by impersonating a second user, the second user associated with a second identity;
accessing a request to execute a command on the remote compute device from the first account; and
determining, based on the first identity of the first account and the second identity of the second user, whether second permission is to be granted to execute the command.

16. The method of claim 15, further including determining whether to grant the second permission based on at least one (1) the local compute device, a (2) an attribute of the command, and (3) a protocol used by the first account to access the remote compute device.

17. The method of claim 15, further including granting the first permission by granting the first account access to a first resource associated with a first protection ring, the command associated with a second resource associated with a second protection ring less privileged than the first protection ring.

18. The method of claim 15, wherein the command is a first command, the request is a first request, and further including:
accessing a second request to execute a second command to export data to the local compute device; and
determining, based on the first identity of the first account and the second identity of the second user, whether a third permission is to be granted to execute the second command.

19. The method of claim 15, wherein the connection includes a data structure indicative of the first identity to the remote compute device.

20. The method of claim 19, further including granting the second permission to execute the command by issuing a token to the local compute device, the token enabling the local compute device to access a resource associated with the command.
